(19) United States
(12) Patent Application Publication
(10) Pub. No.: US 2005/0070279 A1
(43) Pub. Date: Mar. 31, 2005

(54) Device, system and method of selecting channels to be scanned in wireless network association

(76) Inventors: Boris Ginzburg, Haifa (IL); Max Fudim, Kiryat Bialik (IL); Oren Kaidar, Givat Ada (IL); Vladimir Kondratiev, Haifa (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/673,205

(22) Filed: Sep. 30, 2003

(51) Int. Cl. H04Q 7/20

(52) U.S. Cl. 455/434; 455/423

(57) ABSTRACT

There are presented a method, device and system for selecting channels to be scanned by a wireless device that seeks to associate with a network. A wireless device such as for example a station 20 may determine the area in which it is located, identify channels used for association in such area and select such identified channels for scanning. The invention may order the identified channels for scanning based on prior associations of the station or based on characteristics of such channels or of access points transmitting on such channels. Such criteria may be collected and stored in an associative history of a station, which may include, for example, the time of past associations on a channel, the performance of an access point in prior associations or other criteria.

### BACKGROUND OF THE INVENTION

A device seeking to associate with a wireless network such as for example a wireless local area network (WLAN) may scan a set of channels looking for a basic service set (BSS) such as for example those that may be made available by a peer or an access point (AP) or by some other device that provides wireless access to a network or WLAN. The group of channels to be scanned by a wireless device may be determined by such device arbitrarily. Other methods may be used for determining which channels are to be scanned. For example, scanning may begin at, for example, a first channel and may proceed sequentially or in some other order until the channels available to the station have been scanned.

Scanning channels takes time, and a wireless device such as, for example, a station may have to remain tuned to a channel for a designated period of time before proceeding to the next channel. Scanning all the channels available to the station before selecting a suitable or optimal channel on which to associate may cause delays in establishing association of the station with a network such as for example a WLAN.

### BRIEF DESCRIPTION OF THE DRAWINGS

Embodiments of the invention will be understood and appreciated more fully from the following detailed description taken in conjunction with the drawings in which:

FIG. 1 is a schematic diagram of components of a wireless device and of a network in accordance with an exemplary embodiment of the invention;

FIG. 2 is a schematic depiction of tables in accordance with an exemplary embodiment of the invention; and

FIG. 3 is a flow diagram depicting a data flow for identifying channels used for transmissions in an area and scanning such channels in accordance with an exemplary embodiment of the present invention.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well-known features may be omitted or simplified in order not to obscure the present invention. Various examples are given throughout this description. These are merely descriptions of specific embodiments of the invention. The scope of the invention is not limited to the examples given.

Unless specifically stated otherwise, as apparent from the following discussions, it is appreciated that throughout the specification, discussions utilizing terms such as “processing,” “computing,” “calculating,” “determining,” or the like, refer to the action and/or processes of a processor, computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

The processes and displays presented herein are not inherently related to any particular computer, communication device or other apparatus. The desired structure for a variety of these systems will appear from the description below. In addition, embodiments of the present invention are not described with reference to any particular programming language, machine code, etc. It will be appreciated that a variety of programming languages, machine codes, etc. may be used to implement the teachings of the invention as described herein.

As used in this application the following terms may have the following meanings: an ‘area’ may mean a geographic location in which transmission and reception between a station or other wireless device and a wireless network or basic service set is possible. In the context of a BSS or AP or other wireless network system, an area may be for example, the geographic location or other physical area in which a station or other wireless device may associate by way of a particular provider of a BSS or by way of an AP. For example, an area may be an office building or a school campus, or a larger area where association with a particular network or WLAN is available. An area may mean for example a floor or portion of a floor of for example an office building that is within transmission range of an AP or another provider of a BSS or wireless services. An ‘associative history’ may mean for example a record of one or more factors relating to past associations between a wireless device and a network such as for example a WLAN or between a wireless device and a provider of a BSS such as for example a peer or an AP. An associative history may include one or more factors relating to the past experience of a wireless device in associating with a network by way of a particular AP or a particular channel. Such factors may include, for example, the number or frequency of associations between a wireless device such as for example a station and a wireless service set, the quality of such associations, the number of times a wireless device has scanned a particular channel, the number of times a wireless device has been successful in finding a BSS on a given channel, the times of day or day in a week of past associations by a wireless device on a particular channel or by way of a given BSS, or other data. ‘Transmission quality’ may mean for example one or more factors relating to transmission between a wireless device and a provider of a BSS, or for example, between a station and a WLAN. Such factors may include for example, throughput, packet error rates, signal strength, security method used for transmission, etc. Other factors are possible. A transmission quality may be good or suitable if it matches in whole or part, some or all of such factors, as such may be predefined in a wireless device such as for example a station or determined by a user of a station as being of importance to an association. For example, in some associations a user may define use of a particular security protocol for transmissions that may be available on a particular channel as being of great importance, while in other associations throughput may be of greater importance.

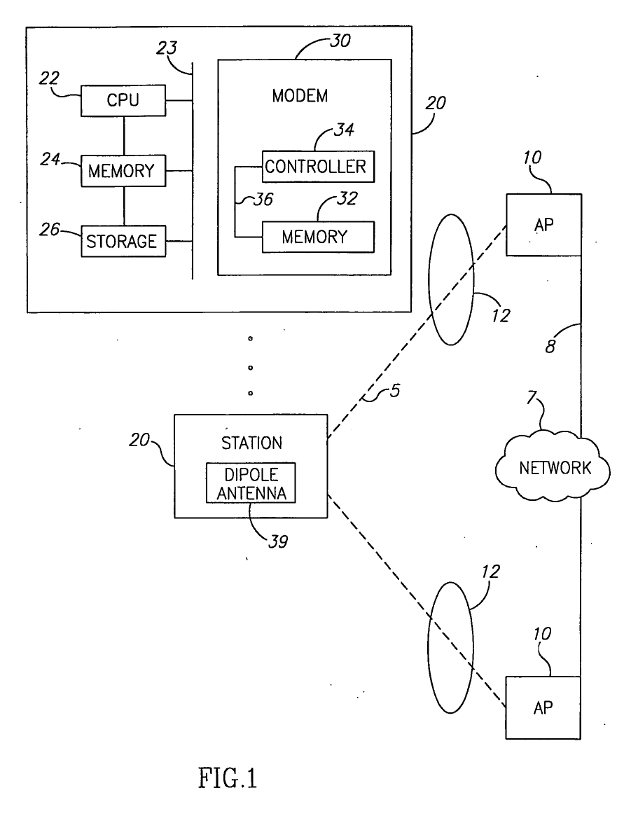

Reference is made to FIG. 1, a schematic diagram of components of a station and a network in accordance with an exemplary embodiment of the invention. Network 7 may for example include one or more peers, such as for example wireless mobile units and one or more providers of a BSS such as for example an AP 10, which may facilitate an association between a wireless device such as for example a station 20 and a network 7. Network 7 may for example be a wireless network or a network that may include wireless components. For example, in some embodiments, network 7 may be a local area network (LAN) with wireless links, such as a WLAN. In other embodiments, network 7 may be for example a wide area network (WAN). A BSS provider such as for example an AP 10 may in some embodiments associate wireless devices such as for example stations 20 with other equipment such as for example personal computers, workstations, printers, etc. A provider of a BSS such as for example AP 10 may be linked to network 7 by wireless communication or by wires 8. Network traffic 5 between a wireless device such as for example a station 20 and a provider of a BSS such as AP 10 may for example be radio waves carrying digital data. Alternatively, traffic 5 may be in different forms such as for example infrared or other electromagnetic waves. In other embodiments, the various devices communicating on a network 7 need not be stations 20 or APs 10 or the other specific devices mentioned herein. Other network devices with different configurations, protocols or structures may be included in embodiments of the invention disclosed herein.

In an exemplary embodiment of the invention, station 20 may seek to associate with network 7, and may scan channels 12 looking for a suitable BSS or AP 10 to facilitate the association. The group or set of channels 12 that may be scanned by station 20 may, in an exemplary embodiment, be identified by a processor such as for example processor 22 or by controller 34 based on for example a list or table of one or more channels 12 that may be stored in for example a memory 32 of a modem 30. Such table may include a record of channels 12 that may be used for transmissions with a particular WLAN or service set, or as may for example be in use for transmissions in the area or location of a particular BSS or AP 10. Processor 22 or controller 34 may collect information, and a memory such as for example memory 32, may store information about interactions or other associations by a device such as a station 20 with networks such as for example a WLAN. Information may also be collected and stored about interactions and past associations between a station 20 and providers of a BSS that it encounters in the course of scanning channels 12. Such information may include for example data about the channels 12 used by a provider of a BSS such as an AP 10, the service set with which such BSS or AP 10 is linked, quality of transmission of a particular BSS provider on a particular channel 12, associative histories or other data. A processor 22 or controller 34 may place channels 12 in an order to be scanned based on such stored data. Other memories or data storage components may be used to store such data.

A provider of a BSS such as for example an AP 10 may be for example a wireless transmitter or wireless transmission device as such as for example a wireless bi-directional communications link or wireless interface means through which wireless devices such as, for example station 20, may associate with a network such as network 7. Other communications links, having structures and functionalities other than those of a BSS or AP 10 may be used.

Station 20 may include, for example, a processor 22 (e.g., one or more central processing units (CPUs) or microprocessors), a memory or storage unit 24 (e.g., one or more random access memories (RAMs) or read only memories (ROMs)), mass storage unit 26 (e.g., a hard disk, a floppy disk, a compact disk, a removable memory or other non-volatile memory), one or more busses 23, and a modem such as for example a wireless modem 30. Wireless modem 30 may include standard computational components, such as, for example, a controller 34, such as for example a microprocessor, CPU, etc, a memory 32, and one or more busses 36. Station 20 or modem 30 may in some embodiments include other components such as for example an antenna such as a dipole antenna 39, a mutli-dimensional antenna, an omni-directional antenna or other types of antennas.

Station 20 may be or include a wireless communication device. For example, station 20 may for example be a personal computer which may for example be portable (e.g., a “laptop”) and which may include wireless modem 30. Wireless modem 30 may be, for example, a mini-PCI wireless network adaptor or may be another type of wireless communications device. Station 20 may be or include other computing devices, such as for example personal digital assistants, cellular telephones, etc.

Network 7 may in certain embodiments be a WAN such as for example the Internet, a WLAN such as, for example, those that may connect a LAN to wireless stations, or smaller networks such as those used by components based on for example, the Bluetooth standard, such as scatternets, micronets or piconets, etc.

Either or both of processor 22 or controller 34 may act as a controller or processor to carry out a method or be part of a device according to an embodiment of the present invention; other controllers or processors may be used. Similarly, memory 32, memory 24 and data storage 26 may alone or in combination store data to carry out the method, or may be part of a device in accordance with the present invention. While in FIG. 1 such components are shown in only one station 20, other stations 20 may include similar components. Some stations 20 may include different sets of components and different functionalities, and may carry out the methods discussed herein in different manners. In other embodiments, having equipment with different configurations, different components may act as a controller 34 or processor 22 for the invention described herein.

In some embodiments, a BSS or AP 10 may communicate or associate with station 20, with network 7, with other wireless components, or with other APs 10. For example, AP 10 may communicate with station 20 using packets, frames or other discreet units of information, to provide station 20 with access to network 7. In some embodiments, AP 10 may operate on a single frequency or channel 12 (represented in FIG. 1 by a set of traffic 5) and may provide a BSS to clients such as for example stations 20 on such channel 12. In some embodiments, a single. AP 10 may operate in an area, although multiple APs 10 may operate in an area and on the same or on different channels 12 if, for example, demand warrants. Other systems for providing access to network 7 are possible.

In an exemplary embodiment, a station 20 may scan channels 12 in an attempt to associate with a network 7 by way of a BSS in such area. Such an attempt may be initiated, for example, at the beginning of a network session in order to associate or establish access between a station 20 and a service set or network 7, or, during a network session for reasons such as for example finding a better path for access to the network 7. Other reasons for scanning during an association session may include for example accessing another network 7 component, or as a result of moving a station 20 out of range of one AP 10 and into the range of another AP 10. In some circumstances an association between a station 20 and a BSS or AP 10 may be inadvertently or momentarily lost, and a scan may be undertaken by a station 20 to reestablish the association with the same or another BSS or AP 10. In some embodiments a station 20 may scan channels 12 on a regular basis while it is already associated with an AP 10 to determine for example if it can improve the transmission quality of its association. Other factors may trigger a scan of channels 12 by a station 20.

In attempting to associate, a station 20, possibly by way of modem 30, may scan some or all of the channels 12 upon which it may be able transmit and receive signals. In some embodiments, scanning may entail tuning a receiver or other signal receiving device of station 20 or modem 30 to a channel 12 and listening for informational packets, frames or beacons or other signals that may be broadcast on such channel 12 by a peer, BSS or AP 10. In other embodiments, station 20 may broadcast a signal such as for example a probe request to find a BSS or AP 10. A BSS or AP 10 which receives such a request may answer with a ‘probe response’ to alert the station 20 as to its availability. This process may be repeated for some or all of channels 12 on which station 20 may be capable or receiving or transmitting signals.

In some embodiments, scanning a channel 12 may take from approximately 10 to approximately 120 miliseconds per channel depending on the beacon period used by the AP 10, if desired. Other time frames may be used. A station 20 may in some embodiments scan from several channels 12 to forty channels 12 or more as part of an attempt to establish an association. Other numbers of channels 12 may be scanned. Certain countries or geographical regions around the world may designate or reserve frequencies, channels 12 or groups of channels 12 for communication by wireless devices such as for example modem 30 or station 20.

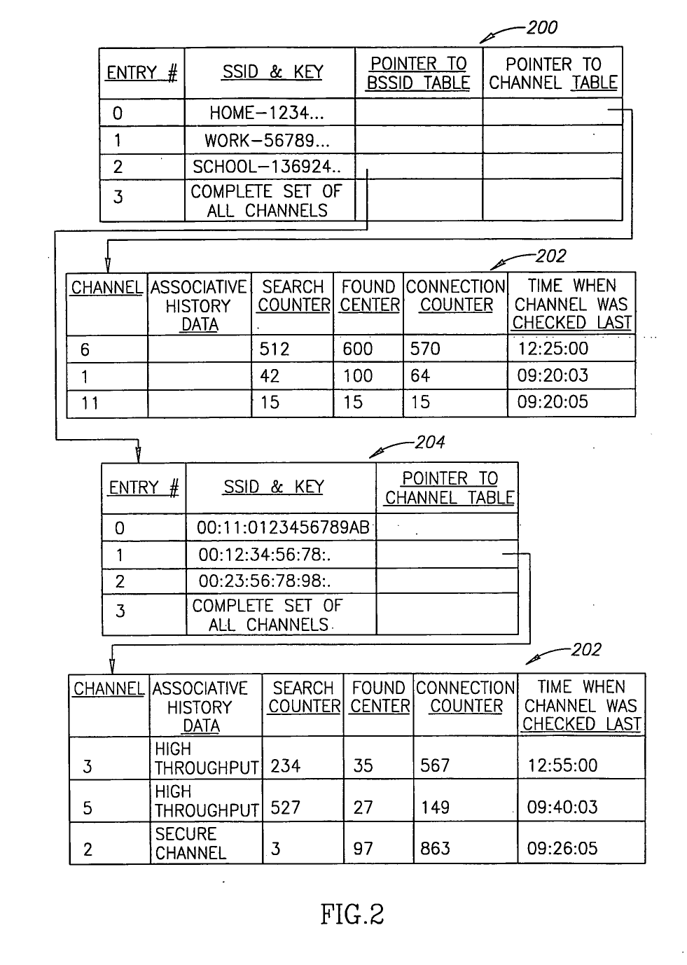

Reference is made to FIG. 2, a schematic depiction of a set of sample tables in accordance with an exemplary embodiment of the invention. An SSID table 200 may be stored in, for example, a memory 32, memory 24 or data storage 26, such as for example, a list or table of one or more WLANs or service set identifiers (SSID) with which a station 20 may have in the past associated, or of which a station 20 is otherwise aware. An SSID may in some embodiments be a 32 character unique identifier to a WLAN that may be found for example in a beacon or probe request that may be sent by an AP 10. Other identifiers may be used. SSID entries in SSID table 200 may point, link to or otherwise be affiliated with a list of one or more channels 12 that are used for transmitting to and from such WLAN or service set. In some embodiments, such list of channels may be in the form of a channel table 202. For example, an SSID table 200 stored in a memory 32 of a wireless device such as a station 20 may list or include the unique SSID of the WLANs with which such station 20 has associated in the past. For example, such SSIDs may include WLANS designated as for example ‘school’, ‘home’ and ‘work’. From past associations by such wireless device or station 20, memory 32 may include a channel table 202 which is linked to a particular entry on SSID table 200 corresponding to the WLAN at school, and which may identify channels 12 such as for example channels 1, 5, 7, and 11 as being used for transmission by the WLAN at for example school or in the area of the WLAN at school. In an embodiment of the invention, a controller such as for example controller 34 of station 20 may when attempting to associate in an area around school, select for scanning the channels 12 that are included on a channel table 202 as is linked to the entry ‘school’ on an SSID table 200.

In some embodiments, in addition to or instead of an SSID table 200, there may be included in a memory of a wireless devices such as for example memory 32, a list or table of one or more BSS identification numbers (BSSID), which may include some or all of the identifying numbers of BSS or APs 10 with which a station 20 may have associated in the past or with which a station 20 is otherwise aware. In some embodiments, a station 20 may use a BSSID that is included in a frame that it receives from a BSS to identify a BSS that is transmitting in an area or to identify an area. In some embodiments, some or all of the entries in a BSSID table 204 may point or link to a list or table of one or more channels that are used for transmission by such BSS and by other BSS or APs 10 in the area of such BSS. Station 20 may select such channels 12 for scanning. For example, a wireless device seeking to associate may identify a BSS whose BSSID is for example 1234567890AB, and is included as an entry on the device's BSSID table 204. Such entry on the BSSID table 204 may link or point to a channel table 202 that may identify channels 4, 9, 13 and 15 as being used for transmission by such BSS 1234567890AB or by other APs 10 located in the area of BSS 1234567890AB. Wireless device may select the identified channels 4, 9, 13 and 15 for scanning when attempting to associate in the area of BSS 1234567890AB. Other structures for lists or tables may be used. For example, an identified area, a WLAN, a BSSID and a list of channels may be included in the same table.

In some embodiments, a processor 22 or controller, such as for example controller 34, may determine the identity of a service set, BSS provider or AP 10 that is in the area or transmission range of a device such as for example a station 20 that is initiating a scan. Based on such determination, a station 20, by way of for example a controller 34, may select for scanning the channels 12 listed in the channel table 202 that is pointed to by an entry on SSID table 200 or BSSID table 204 that corresponds to such service set, BSS or AP 10. For example, in some embodiments, a station 20 that may have momentarily lost or recently ended an association, may be pre-set to assume that the service set or BSS provider that is in its area or within its transmission range is the same as the one with which it most recently associated. Thus, station 20 may in some embodiments determine or assume that the area it is in is the same area it was in before the service interruption; area in this instance may be thought of as the physical area served by a BSS provider or from which an association with a service set may be facilitated. A controller 34 may in some embodiments refer to the SSID or BSSID entry corresponding to its most recent association, and may select for scanning those channels 12 that are listed on a channel table pointed to or linked with such most recently referred to SSD or BSSID entry. In some embodiments, the identity of a service set, BSS or AP 10 that is proximate to or within transmission range or otherwise located within the area or current location where station 20 is situated may be determined based on a frame, such as for example a beacon, that may be broadcast by such BSS or AP 10, which may include SSID or a BSSID data that indicates the source of such frame. Thus the area may be determined by such a frame or beacon.

In some embodiments, an entry in an SSID table 200 may point or link to a particular BSSID table 204 such that for one or more entries on an SSID table 200, a memory such as memory 32 may store a list of BSS or APs 10 that are affiliated with such service set. Such BSSs or APs 10 may further link to channel tables 202 such that for an entry on an SSID table 200, a memory 32 may be able to select all or some of the channels 12 used for transmitting with such WLAN or service set. In other embodiments an entry on an SSID table 200 may point or link directly to one or more channel tables 202. Other structures may be used. In some embodiments, a failure of a scanning process to find a BSS or AP 10 on a channel 12 where an SSID table 200 predicted such BSS to be, may be taken as an indication that the determination as to the location of the wireless device was mistaken and that a next or other SSID entry on an SSID table 200 should be selected.

In some embodiments a memory 32 may include a channel table 202 that lists a complete or relatively complete set of possible channels 12 upon which a station 20 may be capable of associating. Such a ‘default’ or global table or set may be called upon as for example a last resort, to select for scanning all possible channels 12 on which a station 20 may be capable of transmitting in the event that, for example, a transmission device or AP 10 is not found on any of the channels 12 that had been selected through a channel table 202 that was linked to an entry from an SSID table 200 or BSSID table 204.

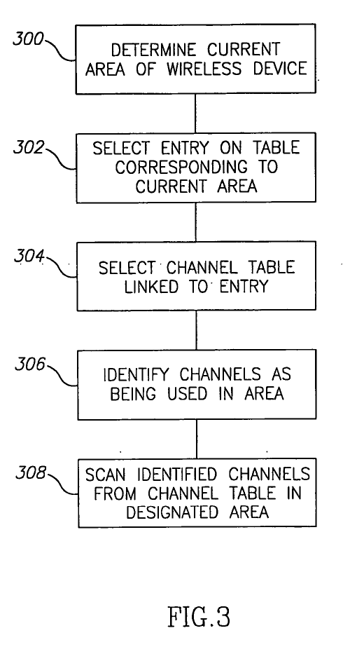

Reference is made to FIG. 3, a flow chart depicting a set of operations for identifying channels used for transmissions in an area, and scanning such channels in accordance with an exemplary embodiment of the present invention. In block 300, a device such as for example a processor 22 of for example a wireless transmission device or a station 20 may determine its current location or the area where it is currently situated. Such determination may in some embodiments be based on assumptions made by a processor 22. For example, such a determination may be based on an assumption that the station is in the same area as it was during its last scan or most recent association. Similarly, a determination may be based on an assumption tied to an associative history of a station 20, such as for example, that during evening hours a station 20 frequently is located in the area of a ‘home’ WLAN. In other embodiments, a determination of the area of a station 20 may be based on geographic data collected by a device, such as data as may be available from a global positioning system or other location finding system. Other bases for determining an area are possible.

In some embodiments, a station 20 may determine the area in which it is located by, for example, detecting or identifying a BSS such as for example provided by an AP 10 that is transmitting frames that are received by such station 20. If the BSSID of such a BSS or AP 10 as may be included in such received frames is listed in a database or table, such as for example a BSSID table 204 of such station 20, the station 20 may identify the channels 12 that are used for transmission in the area of such BSS or AP 10 as such channels 12 are listed in the channel table 202 that is linked to the BSSID entry on such BSSID table.

In block 302, an entry corresponding to the determined area may be selected from a data structure, list or table that is available to a wireless device such as a station 20. Such entry may be selected for example by a controller such as for example controller 34 or a processor such as processor 22 which may compare the determined area wherein a device or station 20 may be located, with the list of SSID or BSSID that may be stored in a memory, such as for example memory 32, to which such device has access. In some embodiments, such an entry may correspond to an SSID that may be listed on an SSID table 200. Alternatively or in addition, such an entry may correspond to a BSSID that may be listed on a BSSID table 204.

In block 304, a set of channels may be identified from a database or other data structure. For example, channel table 202 that is pointed to, linked to or otherwise affiliated with an entry on for example SSID table 200 or BSSID table 204 may be identified or selected. Such a channel table 202 may in some embodiments include a list of channels 12 used for transmissions in the area of a wireless service set, BSS or AP 10.

In block 306, a set of channels may be selected. For example, the channels 12 listed in a channel table 202 may be selected for scanning by a wireless device or station 20 that is seeking association. In block 308, the channels 12 that were identified (for example, on channel table 202) may be scanned. In some embodiments identified channels may be scanned in an order based on data stored in a memory such as for example memory 32. In some embodiments, a controller such as controller 34 or a processor such as for example processor 22 or some other component of a wireless device may place the selected channels 12 into an order for scanning. Such order may in some embodiments be determined based on for example the number of times a device such as station 20 connected to an AP 10 on such channel 12 and when such connection was made, the number of times the channel 12 was scanned in the past and when such scan was conducted, or other suitable factors. In some embodiments, factors included in an associative history may be used in ordering channels 12 to be scanned. For example, a desirable security protocol that may be available on a particular channel 12 that is listed on a channel table 202, may be a factor in determining that such channel 12 should be put, for example, first in an order of channels 12 to be scanned. A specific order need not be used.

Other steps or series of steps may be used, and certain steps may be omitted.

In some embodiments, a station 20 by way of for example a controller such as for example controller 34 and a memory such as for example memory 32 may determine, estimate or assume the current location or area of such station 20, and may identify, for example, the service set or provider of a BSS that may be in such assumed current area. Such service set or BSS may be represented as, for example, an entry on an SSID table 200 or a BSSID table 204. Other data storage formats and organizational schemes may be used.

In some embodiments, the determination or assumption of a current area may be a basis for a controller such as for example controller 34 to select a particular data item, database, or portion of a database. For example, a controller may select an SSID entry from an SSID table 200 as corresponding to the service set in such area. In some embodiments, the determination of an area may be a basis for a controller such as controller 34 to select a BSSID entry from a BSSID table as corresponding to a provider of a BSS in such area. In alternate embodiments, other suitable methods and systems for determining a set of channels based on an area may be used.

Entries such as for example an SSID entry or a BSSID entry may be linked or may point to a data structure such as for example a channel table 202 that may include the channels 12 on which an association may be established with a service set or provider of, for example, a BSS. A station 20 may identify the channels 12 listed on such table as is pointed to by an SSID entry or BSSID entry, and such station may scan the channels 12 listed on such channel table 202. In some embodiments, scanning may continue until all channels 12 on the channel table 202 to which an SSID entry or a BSSID in linked have been scanned.

If a suitable service such as an AP 10 or other provider of a BSS is found on a scanned channel, an evaluation may be made, for example as to whether an SSID that was included in a frame transmitted by such found AP 10 corresponds to the SSID used in the assumed current area. If such SSID does not correspond to the service set available in the assumed current area, a station 20, by way of for example a controller 34, may determine whether the SSID included in the frame transmitted by the found AP 10 appears as an entry on an SSID table 200 of such station 20. If such SSID does not appear on an SSID table 200, the SSID may be added to the SSID table 200 as part of for example, an update of an SSID table 200. If the SSID does appear as an entry on SSID table 200, then such SSID entry may be selected as corresponding to a new, assumed current location. Channels 12 on a channel table 202 pointed to by such selected SSID entry may then be identified and scanned. Other suitable updates, changes, or additions to data structures used may be performed.

If an AP 10 is found on a scanned channel 12, a determination may be made by for example a controller such as for example controller 34, as to whether such found AP 10 matches the criteria for being good or suitable for association by station 20. In some embodiments, such determination may be based on transmission quality factors such as for example signal strength, throughput, security considerations or other characteristics of such found AP 10 or the channel 12 upon which it transmits. The relative importance of such factors may be determined by a user of station 20, or may be pre-programmed into a station 20. Factors other than transmission quality may be used to determine whether an AP 10 or the channel 12 upon which it transmits are suitable or good. If a found channel 12 or AP 10 is suitable, station 29 may attempt an association with such AP 10 or on such channel 12.

If an AP 10 or provider of a BSS that is found during a scan is not good or suitable for an association, a station may, for example, select an entry on a BSSID table 202 corresponding to such found AP 10 or provider of a BSS and scan the other channels 12 on a channel table 202 that is pointed to by such entry, to look on such other channels 12 for other more suitable AP 10 or providers of a BSS in the area.

In some embodiments, a temporary BSSID table 204 may be used to initially store data on providers of a BSS that are found in a scanning process until the location or area of such BSS is determined. Such data may also be stored in for example a temporary BSSID table 204 until for example, other APs 10 in the area of such BSS are identified, until a scan of a group of channels 12 has been completed or until the occurrence of some other event that may indicate for example the table on which such BSSID should be entered.

In some embodiments, scanning of a particular channel 12 may continue until the scan has been exhausted or ‘timed out’ indicating that no service or AP 10 was to be found on such channel 12 in an area. If an AP 10 was expected to have been found on such scanned channel 12, controller 34 may take such failed expectation as an indication that the station 20 is not in an assumed current area, and the controller may advance an SSID table 200 to another entry.

A station 20 by way of a controller such as for example controller 34, may, before advancing to a different SSID entry or at other times, update a channel table 202 or a BSSID table 204 with data that may have been collected during the course of a scan. Such data may include for example the number of times a channel 12 was scanned, the last time it was scanned, the strength of a signal, if any, received on such channel 12, etc. In some embodiments, if an AP 10 is found in the course of a scan, such AP 10 may be added or updated to a table such as for example a BSSID table 204, and the channel 12 upon which such AP 10 is transmitting may be added to channel table 202. Such updates may in some embodiments create a self-learning process where new SSID or BSSID that are found during a scan by a wireless device such as for example a station 20 may be included in subsequent scanning processes, and the channels 12 upon which a BSS transmits may be put into an order based upon prior scans. At one or more points during an association, a station by way of for example a controller such as for example controller 34 may update an SSID table 200 or BSSID table 204 or some other table to indicate the SSID or BSSID entry that was used in the most recent association.

In some embodiments, scanning may continue until all the channels selected, for example all channels 12 on a relevant channel table 202, have been scanned or until a good or suitable channel has been found. If no APs 10 or providers of a BSS are found on the channels 12 listed on a channel table 202, a SSID table 200 may advance to another SSID entry. In some embodiments a station 20, by way for example of a controller such as for example controller 34, may select the best or another AP 10 or provider of a BSS from among the APs 10 that may have been found during a scan, even though such APs 10 may not match the criteria for a good or suitable association.

In some embodiments, a scanning process such as for example that described above may be repeated until an association is achieved or periodically during an association.

It will be appreciated by persons skilled in the art that embodiments of the invention are not limited by what has been particularly shown and described hereinabove. Rather the scope of at least one embodiment of the invention is defined by the claims below.

1. A method of selecting channels, the method comprising:
identifying channels used for transmissions in an area; and
scanning said identified channels.

2. A method as in claim 1, comprising identifying a wireless basic service set operating in said area.

3. A method as in claim 2, wherein said identifying said wireless basic service set comprises assuming a service set is a same service set with which a station recently associated.

4. A method as in claim 1, comprising identifying a basic service set operating in said area.

5. A method as in claim 1, wherein said identifying comprises referring to a list of at least one channel used in said area.

6. A method as in claim 1, comprising selecting a channel upon which to associate.

7. A method as in claim 6, wherein said selecting includes at least evaluating a quality of transmission of at least one of said identified channels.

8. A method as in claim 1, comprising updating a list of channels used by transmitting devices in said area with data collected in a scan of said identified channels.

9. A method as in claim 1, comprising updating a list of service sets with service sets that are identified during said scanning.

10. A method as in claim 1, comprising ordering said identified channels based on data collected about said channels.

11. A wireless communication device comprising:
a memory to store data about at least one channel used by transmitters associated with an area; and
a processor to select for scanning said at least one channel.

12. A device as in claim 11, wherein said processor is to detect a service set and select at least one channel used for transmissions with said service set.

13. A device as in claim 11, wherein said processor is to detect a basic service set operating in said area and to select at least one channel used for transmissions in an area of said basic service set.

14. A device as in claim 11, wherein said memory is to store data about channels used for transmissions with at least one service set.

15. A device as in claim 11, wherein said memory is to store data about transmitters in an area of a basic service set.

16. A device as in claim 11, wherein said processor is to select an access point for association based on a quality of transmission with said access point.

17. A device as in claim 11, wherein said processor is to update said memory with data collected in said scanning.

18. A device as in claim 11, wherein said processor is to order for scanning said at least one selected channel based on data collected in past associations on said at least one selected channel.

19. An article comprising a storage medium having stored thereon instructions that, when executed by a processor, result in:
identifying channels to be scanned in an area; and
scanning said identified channels.

20. An article as in claim 19, wherein said execution of said instructions further result in updating a table of said identified channels with data collected during a scan.

21. An article as in claim 19, wherein said execution of said instructions further result in ordering said identified channels for scanning based on data collected on said channels.

22. A communication device comprising:
a dipole antenna;
a controller to identify channels used for transmissions in an area; and
a memory to store data about at least one channel used by transmitters in an area.

23. A communication device as in claim 22, wherein said controller is to detect a service set operating in said area and select at least one channel used for transmissions with said service set.

24. A communication device as in claim 22, wherein said controller is to update a table of channels with data collected in during said scan.

25. A communication system comprising:
a station;
an access point;
a controller to identify channels to be scanned in an area; and
a memory to store data about at least one channel used by transmitters in an area.

26. A communication system as in claim 25, wherein said controller is used to detect a service set in said area.

27. A communication system as in claim 25, wherein said controller is to update a table of said identified channels with data collected on said at least one channel.
